(19) United States
(12) Patent Application Publication
(10) Pub. No.: US 2010/0070533 A1
(43) Pub. Date: Mar. 18, 2010

(54) Systems and Methods for In-Line Viewing of Files over a Network

(76) Inventors: James Skinner, Singapore (SG); Michael Hewitt, South Jordan, UT (US); Doug Weber, Salt Lake City, UT (US); Gib Reimschussel, Salt Lake City, UT (US); D. Christian Harrison, Salt Lake City, UT (US); Steve Conlee, Pleasant Grove, UT (US); Eugene Skinner, Tokyo (JP)

Correspondence Address: KIRTON AND MCCONKIE, 60 EAST SOUTH TEMPLE,, SUITE 1800, SALT LAKE CITY, UT, 84111, US

(21) Appl. No.: 12/211,440

(22) Filed: Sep. 16, 2008

(51) Int. Cl. G06F 17/30

(52) U.S. Cl. 707/791; 707/E17.014; 707/E17.032

(57) ABSTRACT

Systems and methods for in-line viewing of files over a network such as the Internet are described. The files are organized into groups or lists, thus forming one or more products. The file or files in a single product may include files of various formats. The user uploading files can input or select the order in which the files of the product are to be displayed/played/accessed by other users. When a file is accessed, a determination is made as to the type of file to be accessed and a player or viewer appropriate for the file type is used to provide access to the file for the user. As each subsequent file in the product is accessed, the determination of the appropriate viewer or player is repeated and access to the file is provided accordingly. Multiple files may be simultaneously accessed using multiple players. Access restrictions may also be provided.

### BACKGROUND OF THE INVENTION

1. Field of the Invention

The present invention relates to systems and methods for viewing and downloading documents over a network, and more particularly to systems and methods for in-line viewing of files, such as viewing within a browser, including files in mixed file formats.

2. Background and Related Art

Computer networks, including networks of sizes from local to worldwide (such as the Internet) have provided new mechanisms to distribute information and media from one person or user to another. However, the distribution over networked computers has been limited in many regards. For example, the iTunes® program and service provided by Apple Computer, Inc. of Cupertino, Calif. is limited in that it does not provide for a content creator to upload content and/or to control playback of the content, and also requires download and installation of a player application. Additionally, iTunes requires playback of video or audio from within the iTunes software and does not support viewing or listening to complete streamed files; only a small preview may be streamed to the user—to play the entire files, they must first be downloaded. iTunes also does not support a mix of dynamic and static files/content.

YouTube™ services provided by Google, Inc. of Mountain View, Calif. are similarly limited. YouTube only supports video files utilizing its single media player and does not support lists or content groupings other than a list of all the videos uploaded by a particular user. Additionally, even for the list of all videos uploaded, there is no support for ordering the list. YouTube also does not support content provider control of uploaded content such that the content provider can control playback order or other options. Finally, YouTube is a view-only system that does not allow downloading of the videos; YouTube also does not support payments to obtain further rights (such as download rights) in the video files.

Scribd™ services provided by Scribd, Inc. of San Francisco, Calif. only supports static content. Scribd also does not have a list function that would allow a content creator to control viewing/retrieval of uploaded content during playback. Scribd utilizes a single player, namely the iPaper™ player, which is similar to the FlashPaper™ player by Adobe Systems, Inc. of San Jose, Calif. All documents uploaded for viewing on the Scribd system must be converted to the iPaper format for distribution or playback.

Neither YouTube™ nor Scribd™ have the ability to output more than one file format. While both services are capable of receiving different file formats of the same type (e.g. YouTube™ is able to receive different video formats), the conversion and file output of both services are limited to a single output, and each of the two services always utilizes the same player output: Scribd™ outputting to iPaper™ and YouTube™ outputting to Flash™. Therefore, neither service provides multiple converters capable of handling multiple static and dynamic file types, and neither service provides multiple formatters capable of formatting outputs of multiple file formats for display/access.

Therefore, the currently-available systems and services for distribution of files over networks are limited.

### BRIEF SUMMARY OF THE INVENTION

Implementations of the present invention provide systems and methods for in-line viewing and downloading of files over a network such as the Internet. The files are organized into groups or lists, thus forming one or more products, units, groups, lists, or collections, (collectively “product” or “products,” whether offered for sale or not or whether including a single file or multiple files) each having one or more files. A product may be generated at the time of file upload, or files may be selected for a product at a time subsequent to upload. The user uploading files and/or organizing files into one or more products is considered to be the products' “publisher.” The file or files in a single product, (e.g. group or list) may be of one file type or may include files of various formats. In at least some implementations, the user uploading files or otherwise creating the product (i.e. the publisher), can input or select the order in which the files of the product are to be displayed and/or played by other users, either as a default or as a requirement. In at least some embodiments, the publisher creating the product need not be the creator and/or uploader of every file in the product: products may include files created and/or uploaded by multiple users or anthologies of products created and/or uploaded by other users. In addition, products may include files created prior to the time of upload and/or files created simultaneously with the time of upload, such as by input of text into a text input screen in the user's browser, or live capture of video or photos using a device such as a webcam.

Files that are uploaded and included in products may fall into one of two classes. The first class of files includes files that can be converted and/or formatted for display or other access through a browser or browser plugin/application. The second class of files includes files that cannot be converted or formatted for display or other access through a browser or browser plugin/application. For those files that cannot be converted or formatted, obtaining the file from the product may be limited to download of the file. For those files that can be converted and/or formatted, several processes may occur between upload/creation of the file and viewing or other access by the user. These processes include optional conversion into an intermediate format and formatting for output (e.g. formatting for display or other access within a browser). As products may include multiple types and categories of files, the optional conversion and formatting for output includes formatting disparate types of information in different ways.

A user wishing to view one or more products or a file within a product may perform a search to locate a relevant product to access. Upon accessing a product, a list of the file or files in the product is displayed, or access (e.g. displaying) to one of the files in the product is provided. When access to one of the files is provided, access may begin at a first file in the product, or at some other location, such as at a location selected by the user who created the product (publisher). When access to a file is provided, a determination is made as to the type of file to be accessed (e.g. displayed, played, etc.), and a player or viewer appropriate for the file type is used to display, play, or otherwise provide access to the file for the user. Alternatively, when access to a file is requested, the appropriate formatter is selected for the original or converted file type, and is applied to the file, and the output is passed to the browser (or to some other proprietary interface) by streaming, progressive streaming/download, or other form of download. Part of the selection of the appropriate player/viewer/formatter may involve pinging the user's browser to discover what functions and/or plugins are available.

The formatted output may include a player embedded in the browser page displayed to the user, such that the user may have some control over how the formatted output is displayed or received. For example, the user may have access to player-type controls such as pause, fast forward, rewind, full screen display and the like for video, pause, fast forward, rewind, and volume for audio, and zoom, next page, previous page, scrolling, and the like for textual and other static documents. Thus, the system may make use of multiple available players, and the system makes a determination of which player to embed in the browser page based on the type of file to be displayed. Alternatively, the system makes use of a single player capable of outputting various file types.

As each subsequent file in the product is to be accessed, the determination of the appropriate viewer/player/formatter is repeated and access to the file is provided accordingly. In some implementations, accessing files within the product occurs by selection from a list, and in other implementations, accessing files within the product occurs by navigation, such as button navigation to next/previous files. Additionally, next file access may be configured to be automatic, such as an automatic progression to the next file upon termination of an audio or video file, or after a defined period of viewing a picture.

In some variations, files can be accessed/viewed/etc. (e.g. streamed or limited progressive download to a browser) and can be downloaded, or a choice may be provided. In such variations, some file conversion may occur for the streamed versions to facilitate streaming. Additionally, some conversion may occur to provide a file in a format desired by the user, and may thus occur either at the time of upload or at the time the file is requested. Conversion to a streamed format may occur by use of a file converter. The file converter converts files to formats that are supported by one or more of the viewers and/or players available in the system. The converted file may be used for online access, such as viewing, while the original file may be stored and delivered by download when file download is selected.

In some implementations, access restrictions are utilized. Access restrictions may limit access and/or download to users who have previously purchased a particular product. Further access restrictions may limit access to specific groups or lists of users or to users having a password, certificate, or other identifier. Access restrictions may also limit distribution of a product and/or one or more of the product's files, such as by preventing download. When such restrictions are implemented, files can be accessed through the viewer/player in a streamed format only. This may be useful to prevent copyright infringement or undesired dissemination of the file(s). Still further access restrictions may limit the number of times a product or files within a product may be viewed and/or the number of users who may view the product/file. Such access restrictions may be set at the time of file upload, at the time of product creation, may be provided by system default, or may be altered at some later time.

In some implementations, the products and files displayed, viewed, or otherwise accessed may include both static and dynamic content. Dynamic content includes files such as video and audio files that are based on a sampling over time with the individual sampling units being replayed. Static content includes files such as graphics, text, or a combination of the two that can be displayed as a single view, whether with or without scrolling, and/or with pagination.

In some instances, product content is simultaneously accessed/viewed/displayed in multiple viewers and/or players. Such implementations provide the advantage of being able to display or otherwise access multiple files at the same time. One example of this is displaying textual material and a video at the same time. The viewers and/or players of all implementations may be provided within a browser window with the product's list and/or may be provided within a modal window or a new pop-up browser window.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative computer system for use with embodiments of the invention;

FIG. 2 shows a representative networked computer environment as used by embodiments of the invention;

FIG. 3 shows a representative screen shot of an embodiment of the invention;

FIG. 4 shows a representative screen shot of an embodiment of the invention;

FIG. 5 shows a representative screen shot of an embodiment of the invention;

FIG. 6 shows a representative screen shot of an embodiment of the invention;

FIG. 7 shows a representative flow chart in accordance with an embodiment of the invention;

FIG. 8 shows a representative screen shot of an embodiment of the invention; and

FIG. 9 shows a representative flow chart in accordance with an embodiment of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide systems and methods for in-line viewing and downloading of files over a network such as the Internet. The files are organized into groups or lists, thus forming one or more products, units, groups, lists, or collections, (collectively referred to herein as “product” or “products,” whether offered for sale or not or whether including a single file or multiple files) each having one or more files. A product may be generated at the time of file upload, or files may be selected to comprise a product at a time subsequent to upload. The user uploading files and/or organizing files into one or more products is considered to be the products' “publisher.” The file or files in a single product, (e.g. group or list) may be of one file type or may include files of various formats. In at least some embodiments, the user uploading files or otherwise creating the product (i.e. the publisher), can input or select the order in which the files of the product are to be displayed and/or played by other users, either as a default or as a requirement. In at least some embodiments, the publisher creating the product need not be the creator and/or uploader of every file in the product: products may include files created and/or uploaded by multiple users or anthologies of products created and/or uploaded by other users. In addition, products may include files created prior to the time of upload and/or files created simultaneously with the time of upload, such as by input of text into a text input screen in the user's browser, or live capture of video or photos using a device such as a webcam.

Files that are uploaded and included in products may fall into one of two classes. The first class of files includes files that can be converted and/or formatted for display or other access through a browser or browser plugin/application. The second class of files includes files that cannot be converted or formatted for display or other access through a browser or browser plugin/application. For those files that cannot be converted or formatted, obtaining of the file from the product may be limited to download of the file. For those files that can be converted and/or formatted, several processes may occur between upload/creation of the file and viewing or other access by the user. These processes include optional conversion into an intermediate format and formatting for output (e.g. formatting for display or other access within a browser or through some other proprietary interface). As products may include multiple types and categories of files, the optional conversion and formatting for output includes formatting disparate types of information in different ways.

A user wishing to view one or more products or a file within a product may perform a search to locate a relevant product to access. Upon accessing a product, a list of the file or files in the product is displayed, or access (e.g. displaying) to one of the files in the product is provided. When access to one of the files is provided, access may begin at a first file in the product, or at some other location, such as at a location selected by the user who created the product (publisher). In some embodiments, when the accessing user is provided with a list of files in the product, the system may be configured to permit the user to view the files in an order other than the original order by selecting the file to access from the list.

When access to a file is provided, a determination is made as to the type of file to be accessed (e.g. displayed, played, etc.), and a player or viewer appropriate for the file type is used to display, play, or otherwise provide access to the file for the user. In some embodiments, the player or viewer is displayed in-line within the user's browser, providing a smoother viewing/accessing experience than that available with pop-up windows, the need to open additional software to access the files, or the need to proceed to a new page within the user's browser. Alternatively, when access to a file is requested, the appropriate formatter is selected for the original or converted file type, and is applied to the file, and the output is passed to the browser by streaming, progressive streaming/download, or other form of download. Part of the selection of the appropriate player/viewer/formatter may involve pinging the user's browser to discover what functions and/or plugins are available. It is anticipated that other interfaces, whether standard or proprietary, may be used to provide access to a file as discussed herein. Therefore, any reference herein to access provided through a browser should be interpreted as embracing access through other standard and propriety interfaces, as long as such interpretation is consistent with the reference to a browser.

The formatted output may include a player embedded in the browser page displayed to the user, such that the user may have some control over how the formatted output is displayed or received. For example, the user may have access to player-type controls such as pause, fast forward, rewind, full screen display and the like for video, pause, fast forward, rewind, and volume for audio, and zoom, next page, previous page, scrolling, and the like for textual and other static documents. Thus, the system may make use of multiple available players, and the system makes a determination of which player to embed in the browser page based on the type of file to be displayed. Alternatively, the system makes use of a single player capable of outputting various file types.

As each subsequent file in the product is to be accessed, the determination of the appropriate viewer/player/formatter is repeated and access to the file is provided accordingly. In some embodiments, accessing files within the product occurs by selection from a list, and in other embodiments, accessing files within the product occurs by navigation, such as button navigation to next/previous files. Additionally, next file access may be configured to be automatic, such as an automatic progression to the next file upon termination of an audio or video file, or after a defined period of viewing a picture.

In some variations, files can be accessed/viewed/etc. (e.g. streamed or limited progressive download to a browser) and can be downloaded, or a choice may be provided. In such variations, some file conversion may occur for the streamed versions to facilitate streaming. Additionally, some conversion may occur to provide a file in a format desired by the user, and may thus occur either at the time of upload, at the time the file is requested, or at some intermediate time, such as at a time of low system load/use. Conversion at the time the file is requested may have an advantage of reducing the initial and overall processing loads as well as storage requirements by not converting files into formats not actually required by users. Conversion to a streamed format may occur by use of a file converter. The file converter converts files to formats that are supported by one or more of the viewers and/or players available in the system. The converted file may be used for online access, such as viewing, while the original file may be stored and delivered by download when file download is selected. Multiple file converters may be provided, and the system makes a determination of which file converter to use based on the type of file to be converted, with the various file converters converting files into different file types depending on the type of file to be converted, such as converting various audio files into an audio format suitable for streaming, converting text documents to Flash Paper™, or converting videos to Flash™ format.

In some embodiments, access restrictions are utilized. Access restrictions may limit access and/or download to users who have previously purchased a particular product. Further access restrictions may limit access to specific groups or lists of users or to users having a password, certificate, or other identifier. Access restrictions may also limit distribution of a product and/or one or more of the product's files, such as by preventing download. When such restrictions are implemented, files can be accessed through the viewer/player in a streamed format only. This may be useful to prevent copyright infringement or undesired dissemination of the file(s). Still further access restrictions may limit the number of times a product or files within a product may be viewed and/or the number of users who may view the product/file. These and other access restrictions may be set at the time of file upload, may be set at the time of product creation, may be provided by system default, or may be altered at a later time.

In some embodiments, the products and files displayed, viewed, or otherwise accessed may include both static and dynamic content. Dynamic content includes files such as video and audio files that are based on a sampling over time with the individual sampling units being replayed. Static content includes files such as graphics, text, or a combination of the two that can be displayed as a single view, whether with or without scrolling, and/or with pagination.

In some instances, product content is simultaneously accessed/viewed/displayed in multiple viewers and/or players. Such embodiments provide the advantage of being able to display or otherwise access multiple files at the same time. One example of this is displaying textual material and a video at the same time. The viewers and/or players of all embodiments may be provided within a browser window with the product's list and/or may be provided within a modal window or a new pop-up browser window.

Embodiments of the present invention embrace products including various media and file types. Media/file types are designations that may be applied to one or more components describing how the media/file is to be consumed, and the various types may utilize different media players or viewers. Examples of various types include video, audio, graphical, textual, etc. Embodiments of the present invention further embrace products including a wide variety of categories of files/media, and categories may be understood to refer to the content of the media/file. Examples of various categories of media include: fiction, history, comedy, action, adventure, instructional, tutorial, self-improvement, etc.

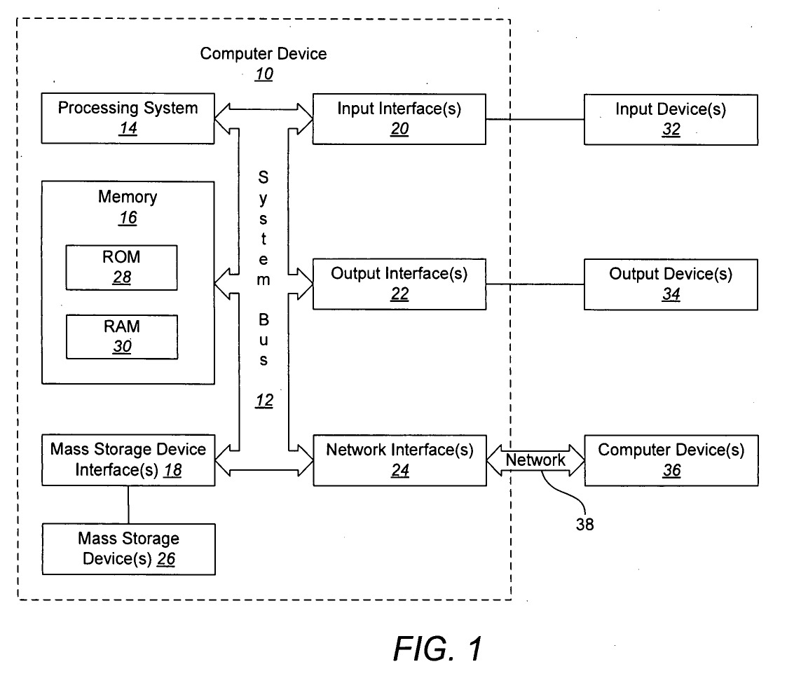

As at least some embodiments embrace the use networked computers and electronic devices or other computer-based systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, consumer electronic devices, and other such electronic environments.

Embodiments of the present invention embrace one or more computer-readable media, wherein each medium may be configured to include or includes thereon data or computer-executable instructions for manipulating data. The computer-executable instructions include data structures, objects, programs, routines, or other program modules that may be accessed by a processing system, such as one associated with a general-purpose computer capable of performing various different functions or one associated with a special-purpose computer capable of performing a limited number of functions. Computer-executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), digital versatile disc read-only memory (“DVD-ROM”) or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, a smart phone, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection connected to a physical computer-readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, optical disk drives, and flash drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

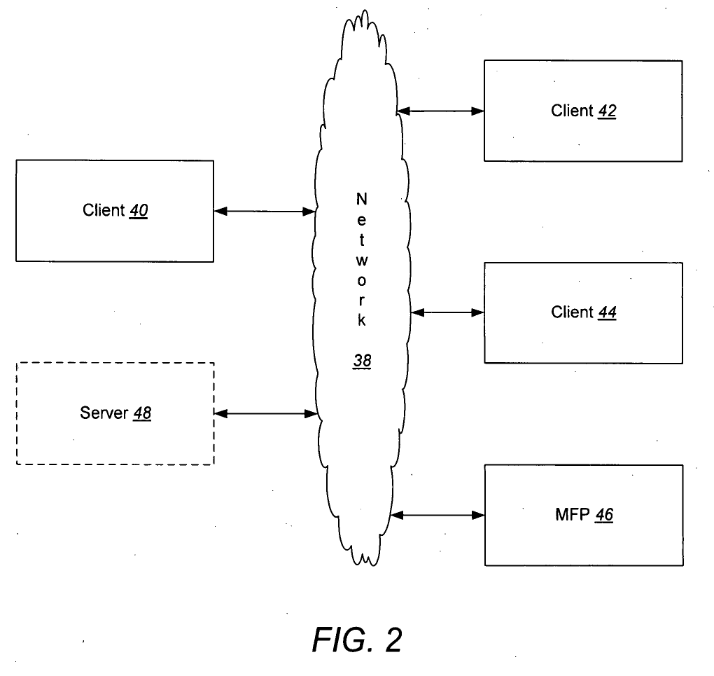

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and to one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Embodiments of the present invention provide systems and methods for in-line viewing of files over a network such as the Internet. The files are organized into groups or lists, thus forming one or more products, either at the time of file upload or at a later point in time. The file or files in a single product (e.g. group or list) may be of one file type or may include files of various formats. In at least some embodiments, the user uploading files can input or select the order in which the files of the product are to be displayed and/or played by other users. Products may include single or multiple files from one or multiple users, and may also include one or more additional products, including products created and/or uploaded by other users. Products containing products may form anthologies of products.

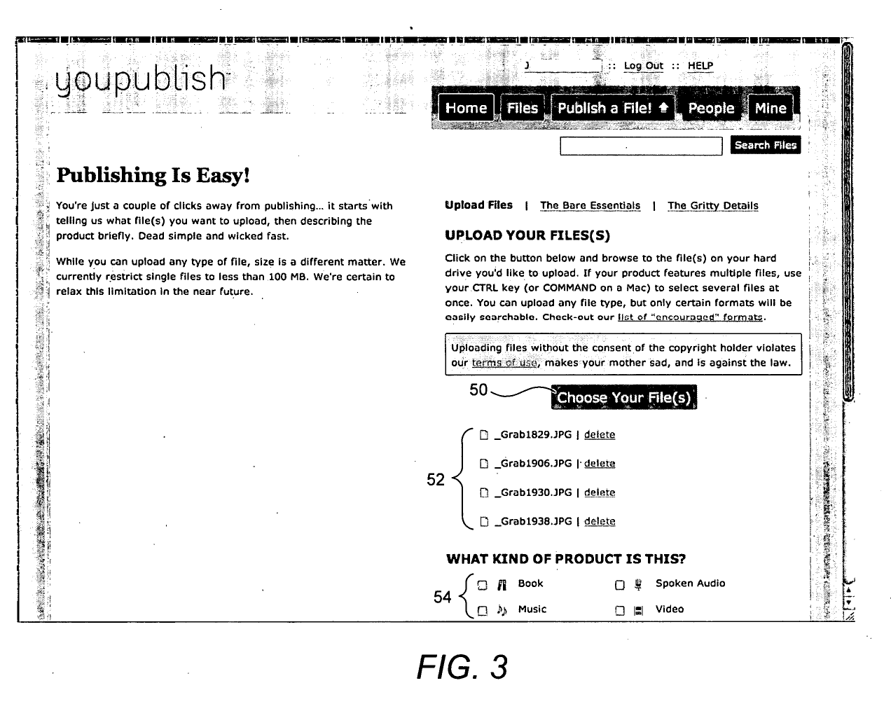

FIG. 3 shows a representative screen shot that may be provided to a content creator or other user who wishes to upload one or more files for distribution as part of a product. Each product can contain one or more files uploaded by the user and/or one or more other products, whether created by the user or by other users. Therefore, while the illustrative discussion below focuses primarily on products having files by way of explanation, it should be understood that the discussed embodiments are also illustrative of products containing other products. The files uploaded by the user may be files previously created by the user. Additionally or alternatively, the files uploaded by the user may be simultaneously or essentially simultaneously uploaded and created, such as by way of uploading of a video through a web cam or generation of a textual file by entry into a web-based text box. Upload may also occur by way of an e-mail address to which users send an attached file to be uploaded.

A user who wishes to create a product (a “publisher”) may be the same user who uploads the files or may be a user using files from one or more other users in addition to or exclusive of the publisher's own uploaded file or files. The publisher can govern what file(s) (and/or other products) are included in a particular product in one of several ways. In a first method, the user governs the files included in the product by uploading the files together at the same time or within a single session. In a second method, the user can select files for inclusion in (or exclusion from) a product at any time, such as by selecting files already uploaded for inclusion in a product, with or without additional files uploaded at the time of forming the product. The files selected for inclusion in a product need not necessarily be files uploaded and/or created by the publisher, but may include files uploaded by one or more other users. Other methods of including files in a product are embraced by the embodiments of the invention. A “product” as used herein is a grouping or listing of one or more uploaded files that are associated together for purposes of searching, accessing, and distribution. In embodiments where access restrictions such as requiring purchase before viewing/download are implemented, purchase of a product may include obtaining limited or unlimited access and/or download rights to some or all files of the purchased product.

As may be seen from FIG. 3, selection of files for inclusion in a product may involve selection of files from a local or remote computer-readable medium. The publisher may select a choose files button 50 to select files for inclusion in the product. Selection of the choose files button 50 may open a browse file window, as is known in the art, to allow the publisher to browse for files for inclusion in the product. Alternatively, selection of the choose files button 50 may provide the publisher with a list of files already uploaded to the system, which may include one or more files in other products of the publisher. In some embodiments, different buttons may be provided to permit the publisher to select between browsing for new files for upload and selecting one or more files previously uploaded.

After the publisher selects one or more files for inclusion in the product, the file(s) may be displayed in a selected files list 52 to assist the publisher in verifying the correct file or files is included in the product's list. In some embodiments, the publisher may be provided with a product category selection 54 that permits the publisher to designate one or more categories describing the works/files contained in the product. The categories may include categories such as book, music, spoken audio, video, photograph, visual art, and any other descriptive category, including more specific category descriptions, such as graphic novel, short story, fiction, audio autobiography, instructional text, tutorial, self-improvement, etc.

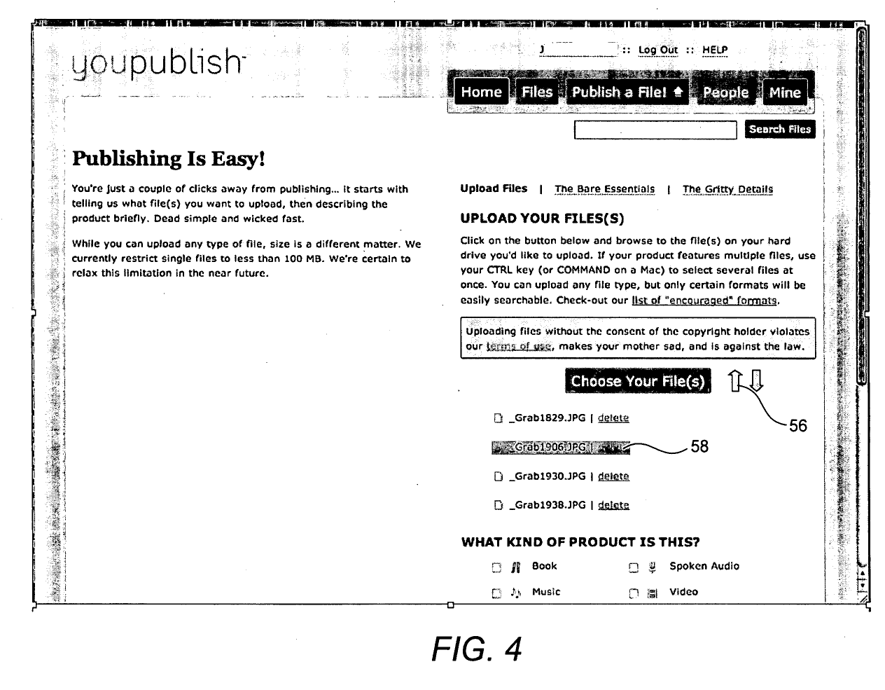

As is illustrated in FIG. 4, the publisher may also elect to modify the order the files are included in the product. This may be done by selecting a file to be included in the product and by selecting a move up/move down icon 56. The publisher may also elect to remove a file from inclusion in the product, such as by selecting a delete file selection 58. Other methods for arranging the order of files and/or adding or removing files from a product are embraced by the embodiments of the invention. Once the ordering of files is as the publisher desires, the product is finalized and may be made available for access to other users. The finalization process may include uploading any files not yet uploaded and packaging the selected files as a product. The files to be included in the product may be uploaded to the system at any time, such as before selecting files for the product (as is the case with embodiments where previously-uploaded files are selected for products), at the time of selecting a file for inclusion in a product, or at the time of finalization of the product.

In at least some embodiments, a product need not remain in a single form indefinitely. In some embodiments, the publisher who generated the product may elect to modify the product at a later time in the fashion described above or in any other fashion. Additionally, the publisher may elect to make the product freely available or, in some embodiments, may choose to put access restrictions on the product. One type of access restriction is a restriction preventing others from downloading files of the product for viewing outside the product. If such access restrictions are in place, other users may be limited to viewing the product in a streaming format where the files of the product cannot be accessed once the users are not accessing the system. As an example, where distribution is by way of a network browser (e.g. accessing the Internet through a browser such as Internet Explorer™ or Firefox™), access may be limited to within a session of the browser, and downloading for viewing or other access outside the browser is not permitted.

Another type of access restriction that may also be used (separately or together with download restriction) is purchase restriction. If such restriction is in place, access to one or more files of the product may be limited to purchasers of all or part of the product. Some limited access (such as preview access) may be provided to non-purchasers, or access may be entirely restricted until a purchase of the product has been made. Further access restrictions may limit access to specific groups or lists of users or to users having a password, certificate, or other identifier. Access restrictions may also limit distribution of a product and/or one or more of the product's files, such as by preventing download. When such restrictions are implemented, files can be accessed through the viewer/player in a streamed format or incremental download/incremental streamed format only. This may be useful to prevent copyright infringement or undesired dissemination of the file(s). Still further access restrictions may limit the number of times a product or files within a product may be viewed and/or the number of users who may view the product/file.

In embodiments where a purchase-type access restriction has been put in place, it may be desirable to limit or restrict modification of the purchased product by the product creator/publisher. For example, a user who has purchased a particular product and later wishes to access the product again only to discover that the product has been modified and that an important portion of the product has been changed or no longer exists may be disappointed. Therefore, in some embodiments, at least some created products are restricted against future changes, even by the content generator or publisher. When a product is restricted against change, the content generator or publisher who wishes to make changes to a product may be required to create a whole new product, or the publisher may be permitted to access a product and modify it, but can only save the modified project as a new project. In some embodiments, the publisher may be permitted to delete or otherwise remove/restrict old projects, such as projects that have been updated and saved as new projects. In some embodiments where a product is to be deleted or removed, prior purchasers of a product may be notified and provided an opportunity to access the product to be deleted.

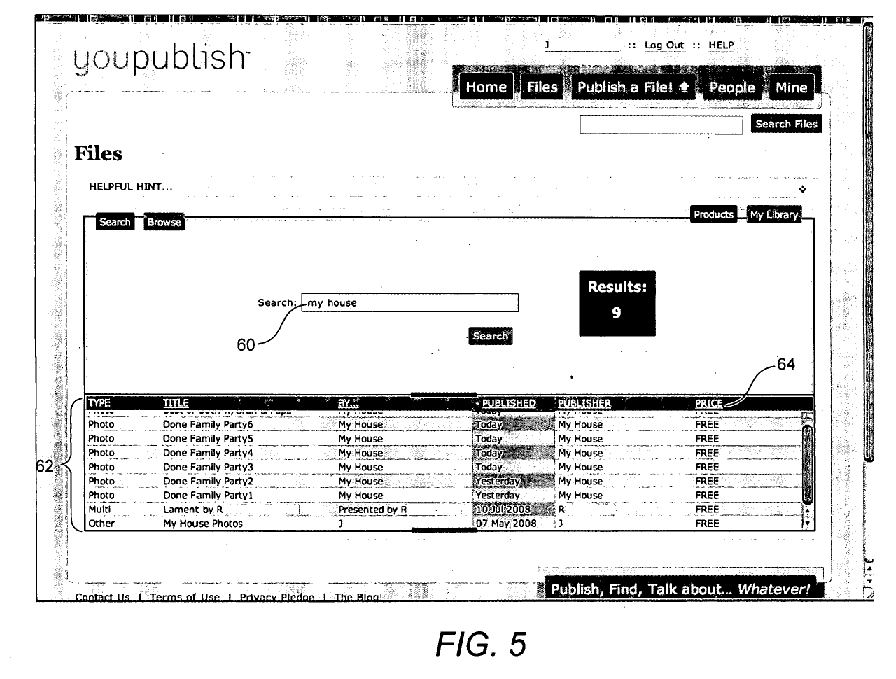

Once a product has been finalized and made available, it may be located by other users, such as in a search. A user wishing to view one or more products or a file within a product may perform a search to locate a relevant product to access. FIG. 5 provides a representative screen shot showing results of a product or file search. In the embodiment illustrated in FIG. 5, the search is conducted by entering search term(s) in a search entry box 60, and results of the search are displayed in a results list 62. In embodiments where a purchase price may be associated with a product, a product price indicator 64 may also be included. The user conducting the search for products may then select a product to view and/or preview.

In one embodiment, upon accessing a product, a list of the files in the product is displayed, or access (e.g. displaying of a visual (picture, text, etc.) file, playing of an audio or video file, etc.) to one of the files in the product is provided. In another embodiment, a determination is first made whether the selected product is a free product or whether the product has access restrictions (e.g. requiring purchase, joining or being added to a group, or passing a test). If the product is a free product, access to the product is provided as described above. In some embodiments the product has access restrictions that include requiring purchase of the product. If the product has such access restrictions, a determination is made as to whether the user seeking access complies with the access restrictions (e.g. has previously purchased the product). If the user satisfies the access restrictions, access to the product and the product's files is provided as described above. If not, the user may be provided with an opportunity to purchase the product, which opportunity, in some embodiments, includes providing a preview of the product and/or the product's file(s) to the user.

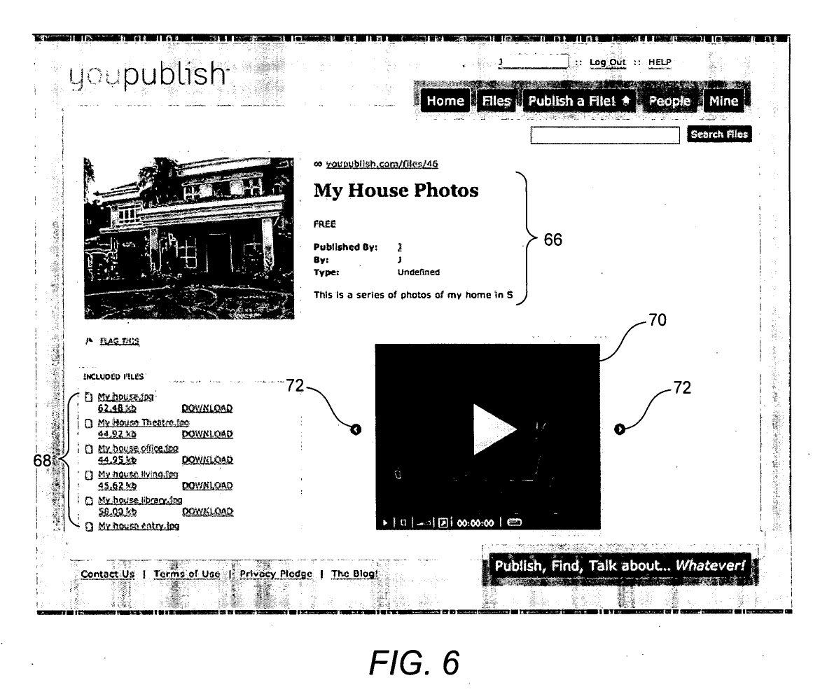

FIG. 6 shows a representative screen shot of an accessed product, and shows an information area 66 showing information about the product, a file list 68 listing the files in the product, and a player or viewer (hereinafter “player 70,” which phrase should be taken to include any viewer, player, or other application for accessing, viewing, displaying, playing, etc. a file in the product). The player 70 is embedded in the web page and accessed/controlled by the viewing user accordingly. When access to one of the files is provided upon access of the product, access may begin at a first file in the product, or at some other location, such as at a location selected by the publisher who created the product. When access is provided upon user selection of a file from the file list 68, access may begin at the selected file, and thus the user may have some ability to override the publisher's ordering in some embodiments. In other embodiments, the publisher that created the project may limit access to within a defined sequence, and thus access by selection from the file list 68 may be disabled.

When access to a file is provided, a determination is made as to the type of file to be accessed (e.g. displayed, played, etc.) and/or format of the data to be accessed, displayed, played, etc., and the player 70 appropriate for the file type is used to display, play, or otherwise provide access to the file for the user. As each subsequent file in the product is to be accessed, the determination of the appropriate player 70 is repeated and access to the file is provided accordingly. In some embodiments, accessing files within the product occurs by selection from the file list 68, and in other embodiments, accessing files within the product occurs by navigation, such as button navigation using navigation links 72 to next/previous files. Each player 70 is typically installed on the accessing user's computer, and is not provided by the service provider hosting the product. If an appropriate player 70 (e.g. browser plugin) for a particular file is not located on the user's computer, the user may be prompted to download and/or install the appropriate player 70.

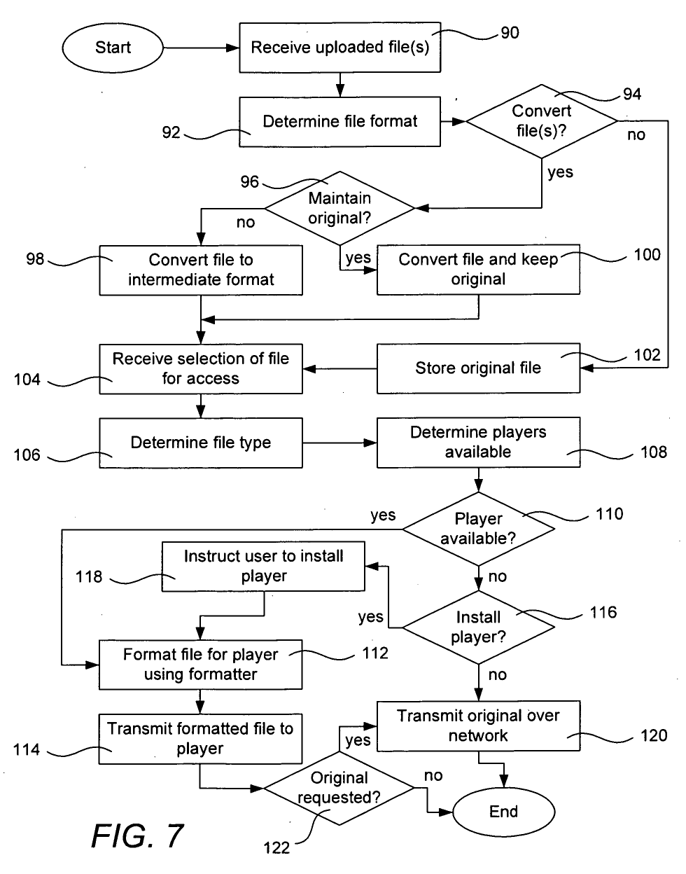

On the server side, several processes take place to ensure that when the user selects a product and file to access, access to the file is provided in as seamless a form as possible. One embodiment of these processes is illustrated with reference to FIG. 7. Execution begins at step 90, where an uploaded file is received. At the time the file is received or at a later time, execution a determination of the file format is made at step 92 and a determination whether to convert the file into another format is made at decision block 94. If it is determined to convert the file to another format, execution proceeds to decision block 96, where a determination is made whether to maintain the file in the original format as well.

If the file need not be saved in the original format, execution proceeds to step 98, where the file is converted into an intermediate format for saving. If the file is to be saved in the original format, execution proceeds instead to step 100, where the file is converted into the intermediate format and also kept in the original format. Finally, if no conversion is to be made of the original file, execution proceeds from decision block 94 to step 102, where the original file is stored. Each of the steps and decisions made between receipt of the uploaded file and receipt of a selection of a file for access at step 104 may occur at any point in time between uploading of the file and delivery of a file for access.

File conversion to an intermediate format, as at steps 98 or 100, permits conversion of files in multiple formats into a smaller number of unified formats for later delivery. However, unlike currently-existing products, that require that all files be converted into a single format, embodiments of the invention utilize multiple intermediate formats. For example, various video formats, such as MPEG4, .mov, .avi, and other movie files may be converted to Flash™-based files. Various audio formats, such as .wav or .mwa may be converted into MP3 format. Similarly, various static media files such as word processor files, spreadsheet files, and still graphic files may be converted into .pdf files or into Flash Paper™-type files. Still graphic files of varying types may be converted into a single still graphic format such as JPEG. The above-listed formats are merely illustrative. Any desired intermediate format may be used. Additionally, as will be appreciated, if the uploaded file is already in a format utilized as an intermediate format, the original will be stored at step 102 without conversion.

At step 104, access to a file is requested by the user, and the system receives a selection of the file for access. Execution then proceeds to step 106, where the file type of the file to be accessed (whether the original file type or the intermediate file type) is determined, followed by step 108, where the player or players compatible/available to provide the user with access to the file are determined. At decision block 110, a determination is optionally made as to whether a compatible player is available. This may be done, for example, by pinging the user's browser to determine what player or players are available. If a compatible player is available to the user, execution proceeds to step 112, where a formatter applies the appropriate format to the file, and then to step 114, where the formatted information is provided to the user's browser, such as through streaming, progressive streaming, progressive download, or download for display, playback, or other access within the browser window.

In some embodiments, the user may be permitted to also download or obtain the original, and therefore execution may optionally proceed to decision block 122, where a determination is made as to whether the original file is also requested. If the original has been stored and is different than the intermediate format originally delivered, and if the user meets all requirements for obtaining the original, execution proceeds to step 120 for transmission of the original to the user over the network, and then ends or loops back to step 104 for selection of another file for access.

If, at decision block 110, it is determined that the user or the user's browser lacks a proper player for displaying, playing back, or otherwise accessing the selected file, execution proceeds to decision block 116, where a determination is made as to whether to prompt the user to install a new player. If the user is to install a new player, execution proceeds to step 118, where the user is instructed to install a compatible player before accessing the file, and after the user installs the player, execution proceeds to steps 112 and 114 for formatting and transmission of the selected file. If, however, it is decided not to prompt the user to install the player, execution may proceed to step 120, where the original file may be transmitted to the user over the network, in this case by direct download, whereupon the user may be permitted to locate a program capable of opening the downloaded file. Of course, the converted file may similarly be transmitted for download and later opening if desired (instead of or in conjunction with the original file).

One example of a file type that may not be amenable to conversion and/or transmission for access by a player is an executable file or application. For example, a particular product may include several file types, including an installation file to install a program, a static instruction manual for the program, and a dynamic instruction video for the program. While conversion and playback through a player may be possible for the instruction manual and the video, the program installation file itself might not be converted and would then be transmitted in its original form for installation on the user's computer.

Thus, systems in accordance with embodiments of the present invention are distinguished in that they provide multiple file converters that convert files into different formats depending on the type of file. They are also distinguished in that they provide a formatter or formatters that format the converted files and/or the original files into the appropriate form for display/access in a browser based on the file type or type of information to be displayed, regardless of the player to be used. The formatter or formatters output differently depending on the type of file to be displayed, played back or otherwise accessed. The player may be embedded in the page display of the user's browser, thus giving the user control over certain elements of how the output is displayed or received.

User control over receipt or display of the information may include controls selected from various groups such as pause, fast forward, rewind, full-screen display and the like for video. Other control groups include pause, fast forward, rewind, and volume for audio. Other control groups for some static file types (e.g. text documents, spreadsheets, and the like) may include zoom, next page, previous page, scroll bars, and the like.

In some embodiments of the invention, different players are used by the user or the user's browser depending on the type of file to be displayed. In alternate embodiments, an improved player may be used that is capable of displaying, playing back, or otherwise accessing both static and dynamic types of files, as is disclosed in co-pending application, Ser. No. ______ filed on the same day as this application, which is incorporated herein by reference in its entirety for all it discloses. If no suitable player is available for a particular file, the user can either be prompted to install an appropriate player, or download of the file in the original format without immediate playback may be provided. In this way, the publisher is not limited in the type of files that may be included in a product, trusting instead that all files in the product will be made available to users.

In some variations, files can be accessed/viewed/etc. (e.g. streamed or limited progressive download to a browser) and can be downloaded. In some such variations, some file conversion may occur for the streamed versions to facilitate streaming, although conversion is not limited to this purpose only. Indeed, in some embodiments, the user may be provided with a choice of preferred formats for receiving the file or files, and in such a case conversion may be undertaken at the time a user requests a particular format of a particular file, thus limiting the processing load that would be entailed in converting all files to all available formats. Conversion to a streamed format or other format may occur by use of a file converter. Thus, embodiments of the invention may include multiple file converters to permit conversion into multiple formats. In such embodiments, a determination is made as to which file converter to use based on the type of file to be converted and/or the destination file type. Various file converters convert files into different file types, such as converting various audio files into an audio format suitable for streaming, converting text documents to Flash Paper™, or converting videos to Flash™ format. The file converter or converters converts files to one or more formats that are supported by one or more of the players 70 available in/to the system. The converted file may be used for online access, such as viewing, while the original file may be stored and delivered when file download is selected. Additionally, in some embodiments, the converted file may be made available for download.

In some embodiments, access restrictions are utilized. Access restrictions may be set at the time of file upload, may be set at the time of product creation, may be provided by system default, or may be altered at some later time. Such restrictions may include restrictions requiring purchase of the product, membership in a group, etc., as described above. Therefore, access restrictions may limit access and/or download to users who have previously purchased a particular product. Access may also be limited to specific groups or lists of users or to users having a password, certificate, or other identifier. Other access restrictions may also limit distribution of a product and/or one or more of the product's files, such as by preventing download. When such restrictions are implemented, files can be accessed through the player 70 in a streamed/incremental download format only. Full download of the product's files may thus be limited. This may be useful to prevent copyright infringement or undesired dissemination of the file(s). Still further access restrictions may be provided, such as restrictions limiting the number of times a product or file of a product may be viewed or the number of users who may view it.

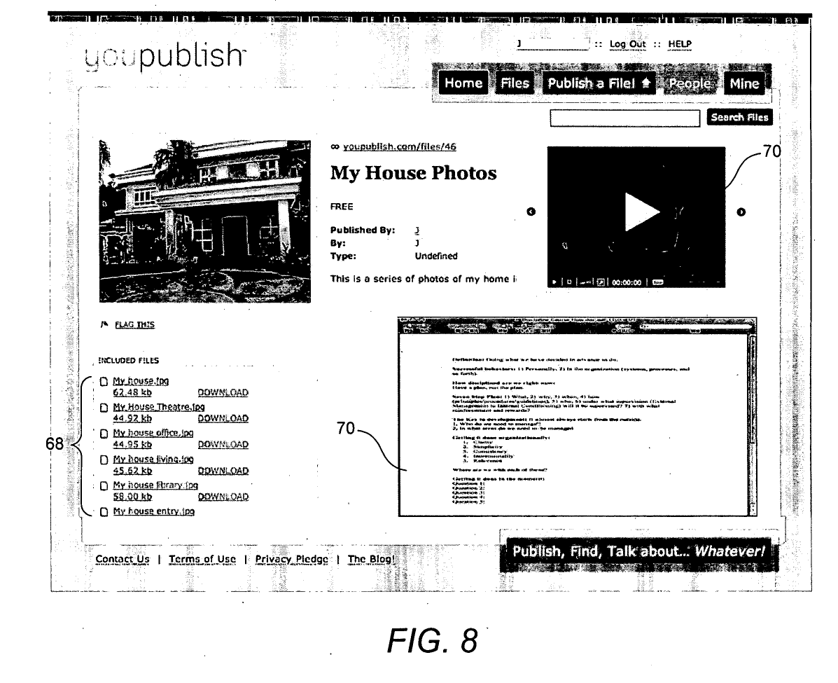

In some embodiments, product content is simultaneously accessed/viewed/displayed in multiple players 70, as is illustrated in FIG. 8. Such embodiments provide the advantage of being able to display or otherwise access multiple files at the same time. One example of this is displaying textual material (as shown in the lower player 70 in FIG. 8) and a video (as shown in the upper player 70 in FIG. 8) at the same time. The players 70 may be provided within a browser window with the file list 68 (and/or with any other information) and/or may be provided within a modal window or pop-up browser window.

In some embodiments, the products and files displayed, viewed, or otherwise accessed may include both static and dynamic content. Dynamic content includes files such as video and audio files that are based on a sampling over time with the individual sampling units being replayed. Static content includes files such as graphics, text, or a combination of the two that can be output in varied or changing formats such as a single view, with or without scrolling, or with pagination. The display of the static and/or dynamic content may be varied in accordance with the accessing user's browser, the player 70, the available space within the browser window, and/or other variables. Additionally, the output may be formatted to display in a new browser window altogether.

Thus, as described above, a system in accordance with embodiments of the present invention includes features selected from the following described features: a receiver for receiving files, which may be of various types and which may be uploaded from various user terminals or clients over a network such as the Internet; the uploaded files; a database for storing the files received by the receiver; an identifier for identifying the file type of the uploaded files, and results of identification may be stored in the database; a file converter for converting files from one format to another; a number of file viewers or players configured to read one or more file types and to configure the information within the files to be viewed within a browser window; a matcher to search the database in response to user queries; an search results outputter that transmits the results of the database search/query conducted by the matcher; a file selector for selecting the file to be accessed; a player selector for selecting the player or viewer to be used to access the selected file; a formatter for formatting the file for output; and a file outputter that transmits the information configured for viewing by the player or viewer in a browser. The viewers or players may include viewers or players for dynamic content such as audio and video requiring progressive download or streaming, and viewers or players for static content such as word processing documents, whether paginated or provided with scrolling, as discussed above.

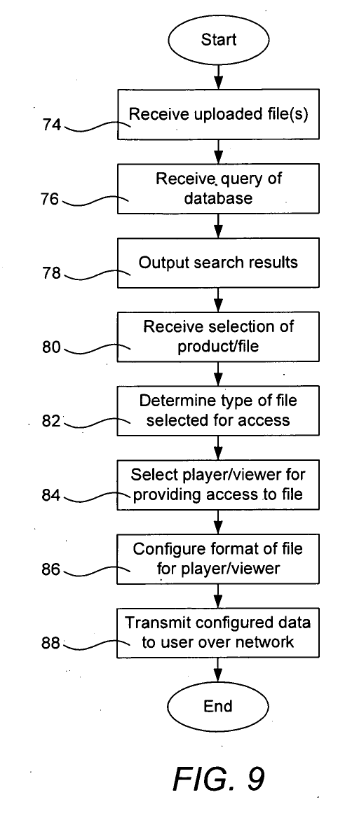

In practice, one system in accordance with embodiments of the invention functions as illustrated in FIG. 9. First, the receiver receives one or more files uploaded by a content-creating user and/or publisher over the network at step 74. In some embodiments, this step includes any steps necessary to generate a complete product, including receiving of access restrictions (including download restrictions and purchase price), and receiving any specific ordering requirements imposed by the content-creating user and/or publisher. Once the product or individual file has been uploaded/created and made available, execution proceeds to step 76, where a query of the database containing the product/file is received. A search is conducted based on the query (e.g. by the matcher), and any results are output at step 78 (e.g. by the search results outputter).

At step 80, a selection of a desired product and/or file is received (e.g. by the file selector), after which execution proceeds to step 82 where a determination is made (e.g. by the identifier) as to the type of file to be accessed. Alternatively, the determination of the file type may occur at another time, such as concurrently with file upload. After the file type of the selected file is determined, a player or viewer may be selected to provide access (e.g. play, permit viewing) to the file (e.g. by the player selector) at step 84. The formatter configures the file for access by the selected player or viewer and the file is delivered via an accessing user's browser (e.g. display, etc.) such as by converting a Microsoft Word™ or Adobe™ portable document format (PDF) document into a Flash™-compatible format or configuring a file for progressive download or streaming for audio and video files at step 86. At step 88, the configured data is transmitted to the accessing user's browser.

The discussed embodiment allows a publisher to upload files of various formats into a single product stored on the database regardless of the viewer/player necessary to read the file. Accessing users can then search for files/products within this single product and the database and select them for access/viewing/receiving/etc. Previous systems only have been able to support files to be played with a single player, and needed to be converted in advance for playback on a specified player or uploaded in the correct file format. Now using the embodiments of the present invention provides content-creating users and/or on-line publishers greater freedom in selecting the types of files uploaded for distribution while at the same time increasing the opportunities for distribution, access, and viewing.

A system in accordance with embodiments of the invention includes features selected from the following described features: a database of files; a receiver for receiving uploaded files to be stored in the database and compiled into a product; a order inputter for inputting the order in which the files are to be accessed, viewed, etc.; a converter for converting files into an intermediate format; a query inputter for receiving queries regarding the files/products stored in the file database; a formatter for formatting files for delivery to a player; and an outputter configured to output the files corresponding to the query in the order previously designated. In this system, which may be combined with features of the other systems discussed above, the content-creating user and/or publisher uploads files, groups them together in a product, and operates the order inputter or other function to control the order of playback/access. The files are then output upon access in the order dictated by the content-creating user and/or publisher. In some embodiments, a regulator may be provided that may prevent playing or other access of a subsequent file in a product until a preceding file has been viewed/accessed. In some embodiments, the content-creating user and/or publisher can later access the product and change the playback order.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for providing in-line viewing of files over a network comprising:
receiving a selection of a selected file for access;
determining a type of the selected file;
selecting an appropriate player, viewer, or format for outputting the selected file based on the file type of the selected file; and
providing access to the selected file by outputting the selected file over a network in a format according to the selected player, viewer, or format.

2. A method as recited in claim 1, further comprising:
receiving an upload of a first plurality of files, the first plurality of files comprising different types of data necessitating different players, viewers, or formatting for accessing, playing, or viewing the contents of the files;
storing the first plurality of files in a database; and
outputting a list of a subset of the files in the database.

3. A method as recited in claim 2, further comprising:
grouping files into a product of associated files; and
providing access to the product and the associated files as a group.

4. A method as recited in claim 3, wherein multiple files from the product are selected for access and wherein providing access to each selected file comprises providing sequential access to each selected file.

5. A method as recited in claim 3, wherein simultaneous access is provided to at least two files from the product.

6. A method as recited in claim 5, wherein the simultaneous access is provided by two different players or viewers.

7. A method as recited in claim 3, wherein a display order or playback order of the files in the product is received from a publisher of the product.

8. A method as recited in claim 3, wherein multiple files from the product are selected for access and wherein a user selecting files for access selects the order in which files are accessed.

9. A method as recited in claim 3, further comprising receiving a display order or playback order of the files in the product from someone other than a publisher of the product.

10. A method as recited in claim 3, wherein the files in the product to display, view, play, or provide access to are selected automatically based on one of the following:
a pre-assigned order of files to display;
a presence of only one file in the product capable of being displayed;
the product having only one file; and
a restriction on access to other files in the product.

11. A method as recited in claim 3, further comprising providing access to subsequent files automatically based upon access activity of the selected file.

12. A method as recited in claim 3, wherein the selected player or viewer is embedded into a user's browser page to give the user control over how the file display occurs, with different controls being provided to the user depending on the file type or type of data to be displayed.

13. A method as recited in claim 3, wherein a single player or viewer is provided having the capability to provide access to files of various types.

14. A method as recited in claim 3, further comprising:
providing a plurality of file converters for converting files selected from the first plurality of files into a file format suitable for streaming, progressive download, or other download for in-line viewing;
making a determination as to which converter to use for each file to be converted based on a file type of the file being converted;
converting a file to be converted into a different file format depending on the converter used for one of the file, a type of the file, or data of the file.

15. A method as recited in claim 3, wherein the first plurality of files comprises files selected from the group of:
files that can be formatted for in-line viewing;
files that can be converted and then formatted for in-line viewing; and
files that cannot be formatted and cannot be converted and then formatted for in-line viewing;
the method further comprising providing a download function for downloading one of:
the files that cannot be formatted; and
the files that cannot be converted and then formatted,
such that a user is able to download the files for local use.

16. A method as recited in claim 15, further comprising providing a file converter for converting a file to be downloaded into a format designated by a user.

17. A method as recited in claim 16, further comprising converting the file to be downloaded at the time of receiving a request for download of the file in the designated format.

18. A method as recited in claim 15, further comprising one of:
providing a download function for files that can be formatted for in-line viewing; and
providing a download function for files that can be converted and then formatted for in-line viewing.

19. A method as recited in claim 18, further comprising providing a file converter for converting a file to be downloaded into a format designated by a user.

20. A method as recited in claim 19, further comprising converting the file to be downloaded at the time of receiving a request for download of the file in the designated format.

21. A method as recited in claim 3, further comprising one of:
providing a download function for files that can be formatted for in-line viewing; and
providing a download function for files that can be converted and then formatted for in-line viewing.

22. A method as recited in claim 3, further comprising providing an access restriction to the files to one of:
a group of users having a password, certificate, or other identifier; and
a user having passed a test.

23. A method as recited in claim 3, further comprising providing an access restriction to a file based on whether a user attempting to access the file has purchased the file or a corresponding product containing the file.

24. A method as recited in claim 23, wherein a number of times the user may access the file on a single purchase is restricted.

25. A method as recited in claim 3, wherein one of a number of times a user may view a file and a frequency with which a user may view a file is restricted.

26. A method as recited in claim 3, wherein download of the selected file is prevented so that the selected file may only be accessed through in-line viewing of output provided from the player, the viewer, or a formatter.

27. A method as recited in claim 3, wherein at least one of the first plurality of files is created at the time of upload.

28. A method as recited in claim 3, further comprising:
pinging a user's browser to identify what browser, plug ins, and software are available on the user's computer;
making a determination based on information obtained from pinging the user's browser as to what format to use to output the selected file.

29. A method as recited in claim 3, wherein providing access to the file using the selected player, viewer, or formatter comprises providing access to the file within a browser.

30. A method as recited in claim 3, further comprising receiving a selection of whether to make a file in the product available for free or paid, and if paid at what price the product should be sold.

31. A method as recited in claim 2, wherein the selected player or viewer is embedded into a user's browser page to give the user control over how the file display occurs, with different controls being provided to the user depending on the file type or type of data to be displayed.

32. A method as recited in claim 2, wherein a single player or viewer is provided having the capability to provide access to files of various types.

33. A method as recited in claim 2, further comprising:
providing a plurality of file converters for converting files selected from the first plurality of files into a file format suitable for streaming, progressive download, or other download for in-line viewing;
making a determination as to which converter to use for each file to be converted based on a file type of the file being converted;
converting a file to be converted into a different file format depending on the converter used for one of the file, a type of the file, or data of the file.

34. A method as recited in claim 2, wherein the first plurality of files comprises files selected from the group of:
files that can be formatted for in-line viewing;
files that can be converted and then formatted for in-line viewing; and
files that cannot be formatted and cannot be converted and then formatted for in-line viewing;
the method further comprising providing a download function for downloading one of:
the files that cannot be formatted; and
the files that cannot be converted and then formatted,
such that a user is able to download the files for local use.

35. A method as recited in claim 34, further comprising one of:
providing a download function for files that can be formatted for in-line viewing; and
providing a download function for files that can be converted and then formatted for in-line viewing.

36. A method as recited in claim 34, further comprising providing a file converter for converting a file to be downloaded into a format designated by a user.

37. A method as recited in claim 36, further comprising converting the file to be downloaded at the time of receiving a request for download of the file in the designated format.

38. A method as recited in claim 33, further comprising one of:
providing a download function for files that can be formatted for in-line viewing; and
providing a download function for files that can be converted and then formatted for in-line viewing.

39. A method as recited in claim 38, further comprising providing a file converter for converting a file to be downloaded into a format designated by a user.

40. A method as recited in claim 39, further comprising converting the file to be downloaded at the time of receiving a request for download of the file in the designated format.

41. A method as recited in claim 2, further comprising providing an access restriction to the files to one of:
a group of users having a password, certificate, or other identifier; and
a user having passed a test.

42. A method as recited in claim 2, further comprising providing an access restriction to the file based on whether a user attempting to access the file has purchased the file or a corresponding product containing the file.

43. A method as recited in claim 42, wherein a number of times the user may access the file on a single purchase is restricted.

44. A method as recited in claim 2, wherein one of a number of times a user may view a file and a frequency with which a user may view a file is restricted.

45. A method as recited in claim 2, wherein the first plurality of files comprises files of static content and files of dynamic content.

46. A method as recited in claim 2, wherein download of the selected file is prevented so that the selected file may only be accessed through in-line viewing of output provided from the player, viewer, or formatter.

47. A method as recited in claim 2, wherein at least one of the first plurality of files is created at the time of upload.

48. A method as recited in claim 2, further comprising:
pinging a user's browser to identify what browser, plug ins, and software are available on the user's computer;
making a determination based on information obtained from pinging the user's browser as to what format to use to output the selected file.

49. A method as recited in claim 2, wherein providing access to the file using the selected player, viewer, or formatter comprises providing access to the file within a browser.

50. A method as recited in claim 2, further comprising receiving a selection of whether to make the files available for free or paid, and if paid at what price the files should be sold.

51. A method as recited in claim 2, wherein the subset of the files in the database comprises all the files in the database.

52. A method as recited in claim 2, wherein the subset of the files in the database consists of a single file of the database.

53. A method as recited in claim 2, wherein the first plurality of files comprise files uploaded by multiple users over the network.

54. A method as recited in claim 1, wherein the selected file is selected from among files comprising different types of data, the different types of data necessitating different players, viewers, or formatting for accessing, playing, or viewing contents of the files.

55. A method as recited in claim 1, further comprising:
receiving a first plurality of files by a method other than upload, the first plurality of files comprising different types of data necessitating different players, viewers, or formatting for accessing, playing, or viewing the contents of the files;
storing the first plurality of files in a database; and
outputting a list of a subset of the files in the database.

56. A system for providing in-line viewing of files over a network comprising:
a receiver for receiving files of various types over a network;
a plurality of files uploaded over the network to the receiver comprising files of varying types requiring different players or viewers for playback;
a database for storing the files received by the receiver;
an identifier configured to identify the file types of the uploaded files;
a file selector for selecting a file to be accessed;
a player selector configured to select a proper viewer or player to access the selected file;
a formatter configured to format information within the files into a format for playing by a player; and
a file outputter that transmits the selected file information over the network.

57. A system as recited in claim 56, further comprising:
a matcher configured to search the database in response to user queries; and
a search results outputter configured to transmit results from the matcher.

58. A system for providing in-line viewing of files over a network comprising:
a database of files;
a receiver configured to receive files and store them in the database;
an inputter configured to receive:
a grouping of files into a product; and
an order of files within the product; and
an outputter configured to output files of the product according to the order.

59. A system as recited in claim 58, further comprising:
an identifier configured to identify the file types of the uploaded files;
a file selector for selecting a file to be accessed;
a player selector configured to select a proper viewer or player to access the selected file; and
a formatter configured to format information within the files into a format for playing by a player.

60. A system as recited in claim 59, further comprising an access controller configured to control access to the product to purchasers of the product only.

61. A method for providing in-line viewing of files over a network comprising:
receiving an upload of a first plurality of files from multiple users over a network, the files comprising different types of data necessitating different players, viewers, or formatting for accessing, playing, or viewing the contents of the various files;
storing the received files in a database;
receiving selection of a file for access;
determining a type of the selected file or a type of data contained in the selected file;
selecting an appropriate player, viewer, or format for outputting the selected file based on the type of the selected file or the type of data contained in the selected file; and
providing access to the selected file by outputting the selected file over a network in a format according to the selected player, viewer, or format.

62. A method for providing in-line viewing of files over a network comprising:
receiving an upload of a first plurality of files from multiple users over a network, the files comprising different types of data necessitating different players, viewers, or formatting for accessing, playing, or viewing the contents of the various files;
determining the type of file received;
converting the selected file into a file format suitable for streaming, progressive, download, or other download for in-line viewing in the user's browser;
storing the converted file in a database of files;
receiving selection of a file for access;
selecting an appropriate player, viewer, or format for outputting the selected file based on a type of the selected file or a type of data contained in the selected file; and
providing access to the selected file by outputting the converted file over a network in a format according to the selected player, viewer, or format.
